(19) United States
(12) Patent Application Publication
(10) Pub. No.: US 2017/0076275 A1
(43) Pub. Date: Mar. 16, 2017

(54) DEVICE AND SYSTEM FOR ELECTRONIC FUND TRANSFER

(71) Applicant: Tracopay Limited, Nairobi (KE)

(72) Inventor: Samson MUTISYA, Thika (KE)

(73) Assignee: Tracopay Limited

(21) Appl. No.: 15/125,174

(22) PCT Filed: Mar. 10, 2015
(86) PCT No.: PCT/IB2015/051728

§ 371 Date: Sep. 11, 2016

Related U.S. Application Data
(60) Provisional application No. 61/952,232, filed on Mar. 13, 2014.
(60) Provisional application No. 61/950,945, filed on Mar. 11, 2014.

(51) Int. Cl. G06Q 20/32; G06Q 20/38

(52) U.S. Cl. CPC G06Q 20/3278; G06Q 20/325; G06Q 20/382; G06Q 20/383

(57) ABSTRACT

A terminal device for making payments, comprises: a memory containing a stored payment amount; a local communication unit to carry out an authentication handshake with a second device located nearby and to carry out a contactless payment by altering said stored payment amount in a complementary manner at said terminal device and said second device respectively; and a synchronization unit to synchronize said stored payment amount with a server(s) over an electronic network following alteration due to the payment. As an alternative, the second device may be located remotely, and communication with the second device may be via the server.

### FIELD AND BACKGROUND OF THE INVENTION

The present invention, in some embodiments thereof, relates to a device and system for payments and, more particularly, but not exclusively, to a handheld payment device used for both on-line and off-line payments.

A problem with existing fund transfer systems is their lack of flexibility. Credit cards and other payment solutions allow anyone to make a payment but only certain entities are trusted to receive payments. Solutions involving paying via one's mobile telephone require the mobile service provider as an intermediary.

Many payment systems have a minimum amount, so that the smallest payments cannot be included. These small payments, known as micropayments, are financial transactions involving a very small sum of money, and may occur on line or off-line, although the term is more commonly used for the on-line case, where automation of the payment is involved. The off-line case usually involves exchange of cash between two parties, and automated examples are use of credit cards for small payments to machines, say to pay for parking. There are other examples of automated payment systems such as mobile payment applications, web based payment systems and SIM based payment applications.

There is no general agreement as to the upper threshold for a micropayment, although sums such as 12 US Dollars and 20 Australian Dollars have been cited. At the lower end, micropayments were originally envisioned to involve much smaller sums of money, however practical systems to allow transactions of less than 1 USD have seen little success, and one problem that has prevented the emergence of micropayment systems is a need to keep costs for individual transactions low, which is impractical when transacting such small sums' even if the transaction fee is just a few cents.

Nevertheless, many real-world transactions are at the lower end of the range, and any attempt to envision a cashless society must cater for low end micropayments.

In the on-line sector, there has been considerable work on micropayments, and two generations of micropayment products can be identified. A first generation of micropayment products began in the mid-1980s and continued to be pursued up to the end of the 20^{th} century, and included both token based and account based products. The token based products used concepts such as e-cash, e-coins, digital cash and tokens, and considerable effort was invested in ways of generating the coins etc, making these products as anonymous and untraceable yet as fraud-proof as the notes and coins they were supposed to replace. Other first generation approaches were account based and depended on transferring numbers between customer accounts and merchant accounts. The first generation is generally considered to have been difficult for end users without technical knowledge of the systems used, and often the underlying technology, such as RSA, stretched the available computer hardware.

The second generation systems have generally, although not exclusively, been account based, and user interfaces have been much easier. The systems have generally relied on on-line validation and thus automatically exclude themselves from the world of off-line micropayments. Both pre-paid systems, which need to be charged with cash in advance, and post-paid, where users receive a bill afterwards, are represented.

Some systems are offered only in a limited range of currencies. Other systems, such as Bitcoin™ define their own currency and thus have a fluctuating exchange rate. Any micropayment system that is to be truly international may at a minimum be expected to allow an end user to make use of his own local currency and thus be able to make micropayments to local merchants.

### SUMMARY OF THE INVENTION

The present embodiments provide a payment device and system that is suitable for both off-line and on-line payments, and can also be used for micropayments. On-line payments are any payments made via an electronic network. By off-line is meant that the payment is not transacted via an electronic network, irrespective of whether the devices carrying out the transaction are at the time connected to an electronic network. The off-line case includes exchanges involving currency between private individuals who may be proximate to each other.

According to an aspect of some embodiments of the present invention there is provided a system for carrying out payments, comprising one or more servers and a terminal device, the terminal device synchronizable with the one or more servers over a first electronic network, the terminal device comprising:

a memory containing a stored payment amount;

a local communication unit configured to carry out an authentication handshake with a second device located nearby and to carry out a contactless payment by altering the stored payment amount in a complementary manner at the terminal device and the second device respectively; and

a synchronization unit configured to synchronize the stored payment amount with a server(s) over the first electronic network following alteration thereof due to the payment.

In an embodiment, the local communication unit is configured to carry out the authentication handshake and the altering of float irrespective of electronic network connectivity.

In an embodiment, in the event that the authentication handshake and the altering of float is carried out in the absence of electronic network connectivity, the synchronization unit is configured to wait with the synchronization until network connectivity is regained.

In an embodiment, the local authentication unit comprises a near-field communication unit or a Bluetooth module or the like.

In an embodiment, the local authentication unit requires a near field communication or radio communication, between the terminal device and the second device.

In an embodiment, the synchronization unit is configured to carry out the synchronization with the server on detection of a low power condition prior to device shutdown.

In an embodiment, the synchronization unit is configured to carry out the synchronization with the server after a predetermined number of transactions or after elapse of a predetermined time or after reaching a cumulative threshold amount of float transacted.

In an embodiment, the local communication unit is only open for authentication for a predetermined amount of time following initiation of the authentication by a user.

In an embodiment, the authentication comprises authentication of the terminal device with the second device using a device identification number for example the UDID-Unique Device Identification referred to herein, an authentication protocol and encryption, thereby to retain anonymity of the user. In an embodiment, the synchronization unit uses a SIM card and authentication protocol to authenticate to the server.

In an embodiment, information exchanged between the terminal device and the second or third device to effect the payment is encrypted.

In an embodiment, the terminal device further comprises a remote communication unit configured to facilitate a two stage authentication handshake involving a third device. The terminal device first authenticates with the server and the server then authenticates with a third device so as to carry out a remote payment. The remote payment involves altering the stored payment amount in a complementary manner at the terminal device and the third device respectively.

According to a second aspect of the present invention there is provided a method of carrying out payments between individual users, comprising:

providing each of a plurality of users with a payment device comprising a memory, a remote communication unit and a local communication unit;

allowing the users to obtain a negotiable amount from an account, the negotiable amount being stored on a server and copied from the server onto the payment device for use;

remotely communicating with the server to synchronize the negotiable amount between the server and the respective device;

one of the users using their respective devices to define a payment in a transaction with one other of the users;

the two users using the local communication unit to authenticate their respective devices to one another using a device to device authentication;

making the defined payment by making complementary changes to respective negotiable amounts at each device; and

resynchronizing the negotiable amounts with the server following the transaction.

According to a third aspect of the present invention there is provided a terminal device for making payments, the device comprising:

a memory containing a stored payment amount;

a local communication unit configured to carry out an authentication handshake with a second device located nearby and to carry out a contactless payment by altering the stored payment amount in a complementary manner at the terminal device and the second device respectively; and

a synchronization unit configured to synchronize the stored payment amount with a server over an electronic network following alteration thereof due to the payment.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor uses volatile memory for storing instructions and/or data and/or a non-volatile storage, for example, a magnetic hard-disk and/or removable media, for storing instructions and/or data. Optionally, a network connection is provided as well. A user output device such as display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified diagram showing a system for providing payments or funds transfers according to a first embodiment of the present invention;

FIG. 2 is a simplified block diagram showing certain features of the payment device of FIG. 1;

FIG. 3 is a block diagram showing the device of FIG. 2 in greater detail;

FIG. 4 is a system chart showing relationships between different levels of the system of FIG. 1;

FIG. 5 is a chart showing the different entities participating in the relationships of FIG. 4;

FIGS. 6, 7, 8, 9, 10, 11, 12, 13, 14, 15, 16, 17, 18, 19, 20 and 21A are a series of screens of the device of FIG. 1 when carrying out a contactless payment;

FIGS. 21B and 21C show respectively a conventional keypad and screen embodiment of the device and a touch screen embodiment of the device;

FIG. 21D shows the placement of the finger print reader of the device;

FIG. 22 is a simplified flow chart illustrating registration of the device of the present embodiments to a new bank account and the case of linking the device to an additional bank account, according to embodiments of the present invention;

FIG. 23 is a simplified flow diagram illustrating a procedure for withdrawing funds from a bank account to use as float on the device, according to an embodiment of the present invention;

FIG. 24 is a simplified flow diagram illustrating a procedure for depositing funds from the device into a bank account, according to an embodiment of the present invention;

FIG. 25 is a simplified flow diagram illustrating a procedure for making a payment to another device in close proximity, according to embodiments of the present invention;

FIG. 26 is a simplified flow diagram illustrating a procedure for making payment or a funds transfer to another device which is remotely located from the payer or sender, according to embodiments of the present invention; and

FIG. 27 is a simplified flow diagram illustrating a procedure for synchronization according to embodiments of the present invention.

### DESCRIPTION OF SPECIFIC EMBODIMENTS OF THE INVENTION

The present invention, in some embodiments thereof, relates to a payment device and system and, more particularly, but not exclusively, to a device for allowing automated payments by individuals having the device without the need to be connected to a network at the time the payment is made.

A device for carrying out payments contains a representation of an amount of money, hereinafter a float, typically drawn from a single or multiple bank accounts or the like, however after withdrawal from the bank account, the bank account is no longer involved. The device is able to make exchanges with the floats of other devices of amounts that the current float allows, including very small amounts. The devices may communicate using near field communication technology or Bluetooth technology or the like, and this may include touch authentication or tap authentication.

In an embodiment, the device may only be open for authenticating with the other device for a few seconds following user initiation of the transaction.

If a network is available then the devices may use the network to communicate.

The devices may synchronize to a central server, or distributed servers following payment transactions, however the synchronization does not need to be at the time of the transaction, thus allowing transactions to occur when there is no network connection.

Transactions made without network availability lead to late synchronization with the server, as the device subsequently comes on line and the device may use data logs to hold transaction data from recent transactions for late synchronization. Late synchronization may further include an automatic synchronization when switching off or at low power, and the device may insist on a synchronization after a given number of transactions and/or after a certain cumulative threshold amount transacted and/or after a certain time period has elapsed. It is noted that during synchronization, as data logs are saved in the servers, some of the data logs are deleted in the devices. This frees up space in the database located in the device. Not all logs are deleted, and the logs remaining allow a user to access a mini-statement from the device. After the synchronization process, revenue calculation, allocation and other processes may occur in the servers. It is further noted that, in an embodiment, revenue calculation, allocation and other processes do not occur in the devices but at the servers, so the synchronization process facilitates revenue calculation, allocation and other processes to take place and to provide records of transactions made, to the device provider's servers.

The device may use a SIM card and work with the cellular network, particularly with the GPRS or equivalent. The SIM card may be used to authenticate to the server so that the device can receive its float. On the other hand, the SIM need not be the authentication used with other devices when exchanging funds or effecting payments. Rather the device may become an anonymous transaction device by use of a device number as identification, as opposed to information of the user. Instead of using a SIM card, the device may be tethered using Bluetooth or appropriate communication technology to a mobile phone, so as to enable the device to use the mobile phone as an anchor to communicate with servers.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

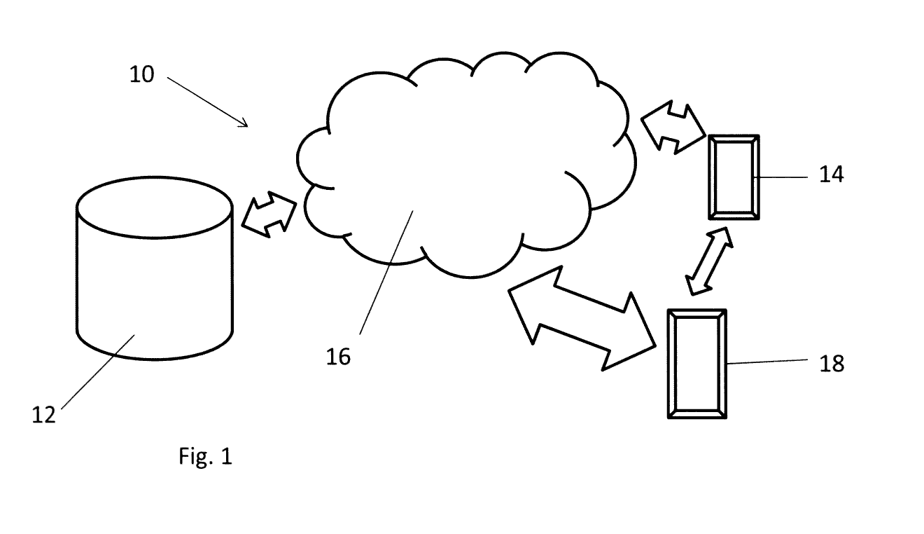

Reference is now made to FIG. 1, which is a simplified diagram illustrating an exemplary system 10 for carrying out payments, according to an embodiment of the present invention. The system comprises a server 12 whether central or distributed and a terminal device 14. The servers are in contact with banks and like financial institutions and allow each user to obtain an amount for use via his/her terminal device. The terminal devices may be synchronized with the central server over a first electronic network 16, which may be the Internet, or may be the cellular network. In the case of the Internet, connections may be via WiFi or like access points. Terminal device 14 may carry out a payment transaction with another terminal device such as device 18 which can be proximate or remote.

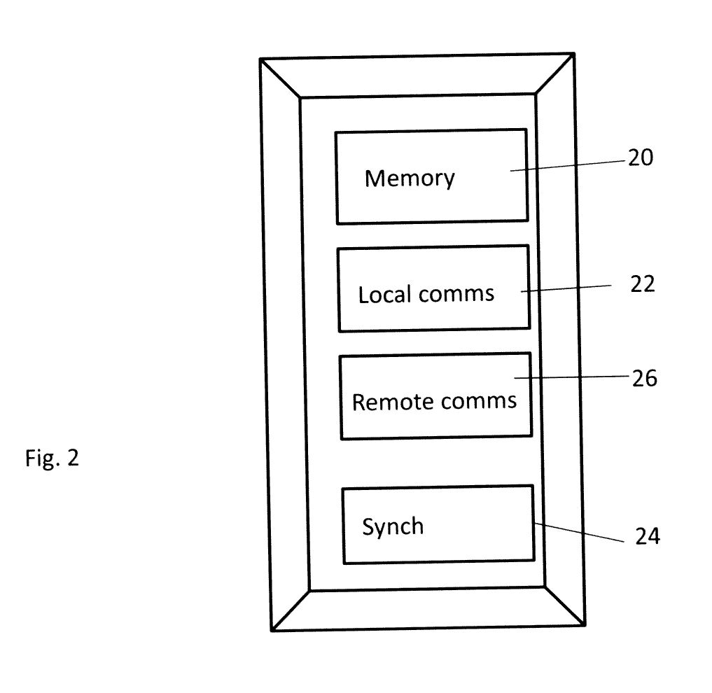

Reference is now made to FIG. 2, which is a simplified block diagram illustrating the internal structure of the terminal device 14 of FIG. 1.

The terminal device includes a memory 20 which stores a payment amount, being an amount available for transactions. The payment amount is money obtained, for example money withdrawn from a bank account, or obtained from another payment device, or any like electronic store of funds, together with any money paid to the device in the course of payment or other transactions such as cashing in at an agent outlet. The payment amount on the device may be the same as a payment amount stored for the same user in the server, except that the server is updated by the device periodically to inform regarding any payment transactions that have taken place in the meantime, as will be discussed in greater detail below. The payment transactions may be synchronized to the server in real time if a connection is available, but if not then the synchronization may take place as soon as a connection is available.

A local communication unit 22 carries out an authentication handshake with a second device located nearby, such as device 18 in FIG. 1, to carry out a contactless payment by altering the stored payment amount in a complementary manner at the terminal device 14 and the second device 18 respectively. Thus if a transaction is for an amount X, then the payment device ensures that the amount X is deducted from the payee and is added to the payer. In addition, transaction fees may be charged to one or both parties.

A synchronization unit 24 synchronizes the stored payment amount with the central server over the first electronic network following alteration due to the payment or any other transactions done by the device. As mentioned, the local communication unit may carry out the authentication handshake irrespective of electronic network connectivity. In the event that the authentication handshake is carried out in the absence of electronic network connectivity, the synchronization unit 24 waits until network connectivity is regained. The synchronization unit may additionally carry out synchronization with the server on detection of a low power condition, so as to ensure that the device and server are fully synchronized prior to device shutdown. The synchronization unit may insist on carrying out a synchronization with the server after a certain number of transactions, and/or after a certain cumulative threshold amount transacted and/or after a certain time period has elapsed to ensure that the server does not get too far behind and or minimize the risk that a large amount of transactions will not end up at the server in the case the device is damaged.

The local authentication unit may be implemented using a near-field communication (NFC) unit. Near field communication (NFC) is a set of standards for smartphones and similar devices to establish two way radio communication with each other by touching them together or bringing them into proximity, usually over distances not exceeding tens of centimeters. The local communication unit may also be implemented using Bluetooth technology.

The local communication unit may only be open for authentication for a predetermined amount of time following initiation of the payment and the authorization of the payment by a user. Thus after defining the transaction at the device, the device may shut down the transaction after a certain number of seconds if the transaction partner is not found. The payment recipient may also have to activate their device so that they can receive a payment and their device once activated likewise has a window period of a certain number of seconds to authenticate and accept a payment.

Authentication between the two devices involves authentication of the devices themselves, not authentication of the user or of an account, thus retaining anonymity of the users. The authentication may use a device identification number, authentication protocol i.e. zero knowledge authentication and encryption. Hash functions or public key encryption may be used to positively identify the devices as genuine.

On the other hand, in authenticating with the server, the synchronization unit 24 may use a SIM card, or alternatively device-level or other appropriate authentication protocol may be used or a device identification number may also be used. The server needs to know, not just that the device is genuine but to which account/user the device belongs. Remote communication unit 26, discussed further below, may facilitate the authentication by enabling the connection with the server.

Information exchanged between the terminal devices to carry out the payment may be encrypted, and the use of encryption provides further certainty as to whether the device with which the transaction is made is genuine or not.

The device may further comprise a remote communication unit 26. The remote unit may carry out an authentication handshake in which the terminal device authenticates with the server, and the server then authenticates with a third device so as to facilitate the remote payment or money transfer with the third device. The terminal device and the third device do not directly authenticate each other in this case. The third device may be located remotely over the cellular network or the Internet or any other network. As mentioned above and discussed in greater detail below, the synchronization process may use the remote communication unit. Likewise, device updates, and remote disablement also use the remote communication unit.

The terminal device may fit in a wallet and may incorporate mobile communication technology, memory and Near Field Communication (NFC) technology. An embodiment has the dimensions of a credit card (85.60×53.98 mm) but slightly thicker. The terminal device may also have a finger print reader which is useful to authenticate the owner of the device.

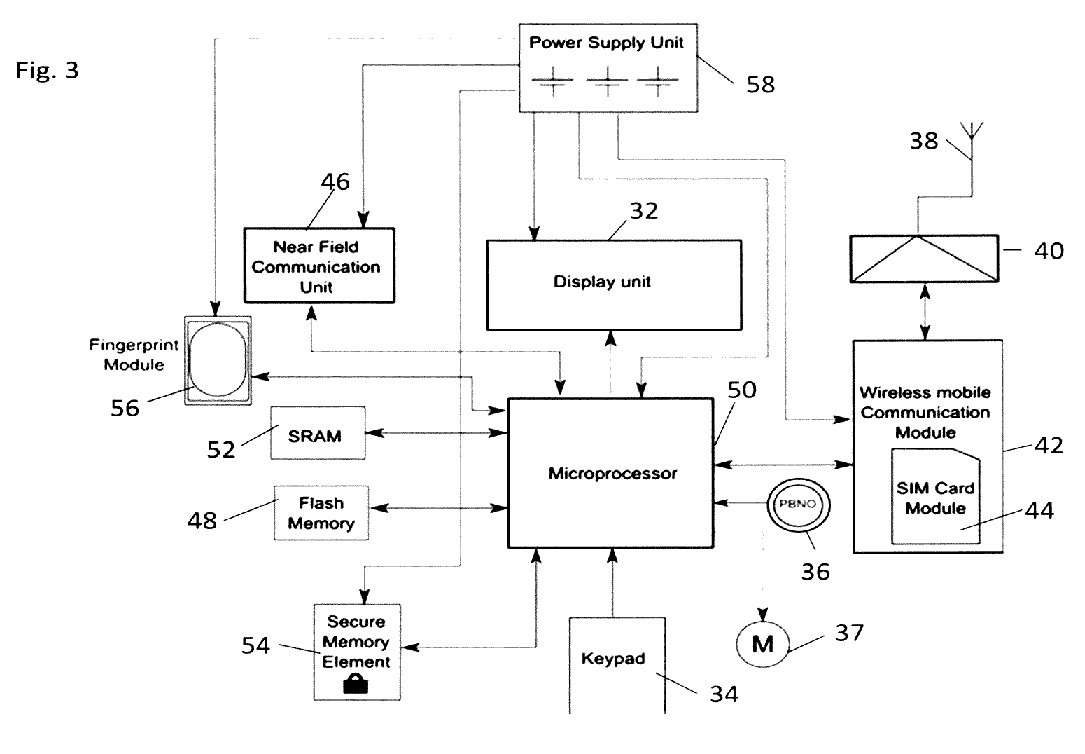

Reference is now made to FIG. 3, which is an internal block diagram of the device of FIG. 2. A user interface includes a display unit 32, a keypad 34, a push button 36 (PBNO—Push Button Normally Open) and a vibrator motor 37. The push button facilitates quick access of information for example allowing users to access their float balance. The vibrator motor enables users to receive a physical stimulus when an important event has occurred for example when a transaction is successfully done. The keypad and display unit may be combined as soft keys and a touchscreen in one embodiment intended for familiarity to smartphone users.

The synchronization unit referred to above communicates using an RF antennae 38, modulator 40, the wireless communication module 42, which may be a dual, quad or penta-band GSM module, a CDMA module or even a Bluetooth or WiFi module, and the SIM card module 44. The wireless communication module may provide a GPRS, or any other communication protocol, connection to the mobile service provider's network. Thus in this regard, the device may mimic a GPRS modem transferring data—transaction logs and other forms of data and instructions to and from the servers. The device may connect to the servers through a Virtual Private Network (VPN) for the purpose of synchronizing transaction logs held in its secure element with those held in the servers. The VPN connection may also be used to send security updates, firmware patches and other module updates so as to make the device more secure or increase its functionality or efficiency.

The Near Field Communication (NFC) unit 46 enables the transfer of transactional information between the devices, within close proximity as discussed above, affecting contactless—payments. The information exchanged by the NFC unit 46 is typically encrypted.

Processor 50 provides overall control and SRAM 52 provides additional memory functions for the processor. Data may be temporarily stored in the SRAM for immediate access by the processor during processing. The microprocessor 50 is the core processing brain of the device. All calculations, interrupt handling, error and exception handling are coordinated by the microprocessor. The flash memory 48 may also holds the operating system, the various software modules, updates and patches.

The secure element 54 holds sensitive information such as transaction logs, float balance, user identification number, device identification number, security keys and also performs cryptographic operations. When information is received by the NFC unit from a second payment device, the data is transferred to the microprocessor. The microprocessor performs the necessary decryption to extract the command from the received data. This command is then transmitted to the secure memory element, which is programmed to only accept specific commands executing a challenge-response protocol before releasing or accepting information. If the information provided from the microprocessor is correct, then the secure element releases the requested information to the processor or accepts the requested information for the processor. The microprocessor then applies another encryption protocol to the data, which data after encryption is then forwarded to the NFC module for further transmission to the second payment device.

The key features of the communication are as summarized below:
The NFC receives information that is already encrypted and as such, any sniffing by hacking devices may only retrieve data that is encrypted and hence useless
The microprocessor can decrypt the information received but cannot use it unless it receives the correct data from the secure memory element
The secure memory element can only release information based on the provision of a correct request code from the microprocessor
Information transferred among the microprocessor, secure memory element and NFC device is partitioned such that any compromise of one part of the system may not affect security of the stored information.

The microprocessor is the only unit in the system that can communicate with the wireless communication module. Information transferred between the microprocessor and the wireless communication module may also be encrypted before transmission. Credentials to connect to the network may be stored in the secure element.

The finger print module 56 is used to authenticate a user before they can use the payment device. For fingerprint authentication, images of the authorized fingerprint may be stored in the fingerprint module. The microprocessor need not be involved with the relatively complex fingerprint matching activities and thus avoids introducing any additional time lag into the system.

The device may contain a battery 58 which powers all the electronic components.

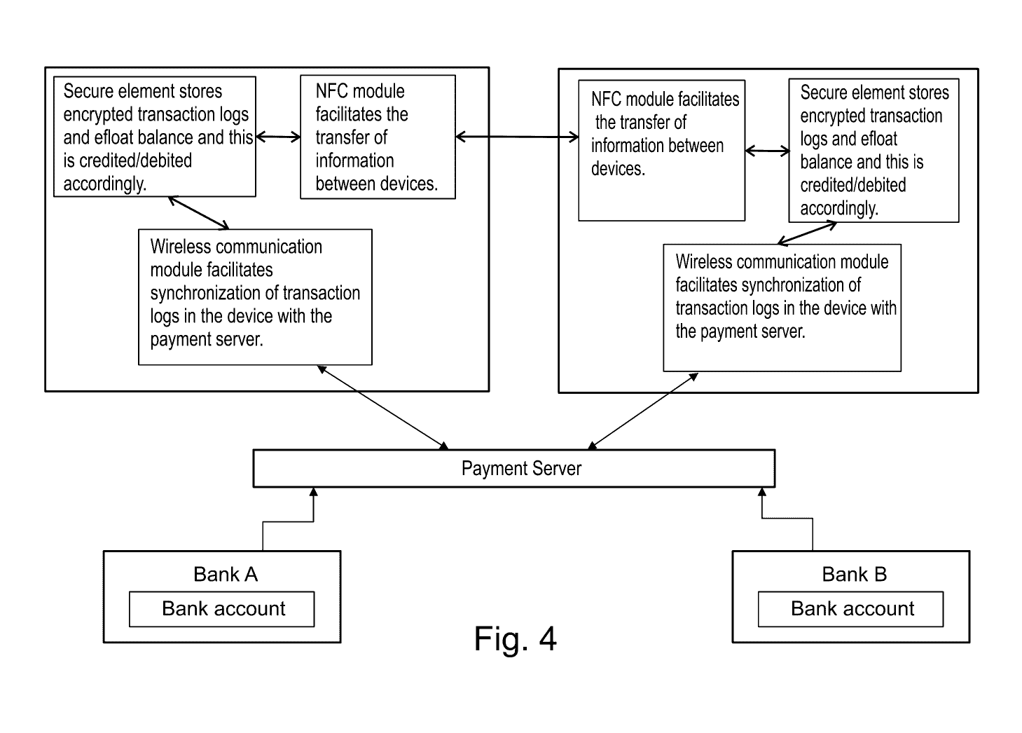

Reference is now made to FIG. 4 which is a process diagram illustrating how the different parts of the device work together. Electronic funds can be withdrawn or deposited from a bank account or from any electronic store of fund and loaded or uploaded into the device via the system servers. The wireless communication module which may be a GSM module, updates the device with the amount from the servers. The device is designed so that the amount held in the device can only be set from the servers via a valid SIM identification and preferably through a VPN connection, or changed through a payment transaction. The amount is securely stored in the secure element. For a payment, the device interface is used to define the transaction and then the two parties to the transaction authenticate their devices to each other via the NFC unit. The transaction leads to changes in the amounts held in the secure element at the two devices, which are then updated at the servers. Surpluses on the device can subsequently be credited to the corresponding user's bank account.

Devices in disparate geographical locations can send each other float via the device provider's servers using their remote communications abilities, for example GPRS, Bluetooth or WiFi radio modules.

Different users are able to make monetary transactions between themselves despite the fact they bank with different banks, and despite the fact that neither of them have a POS system or like setup. Furthermore, the device is not limited to a single bank account but rather, in the event of a user having multiple bank accounts, each can be accessed via the same device.

As well as withdrawing from bank accounts, transaction amounts on the device may be obtained as credit from credit issuing institutions. Furthermore, the device can also function as a credit card, with an allowed spending limit and payment after the fact to the bank. In this case, transaction data can be used to determine a user's credit limit.

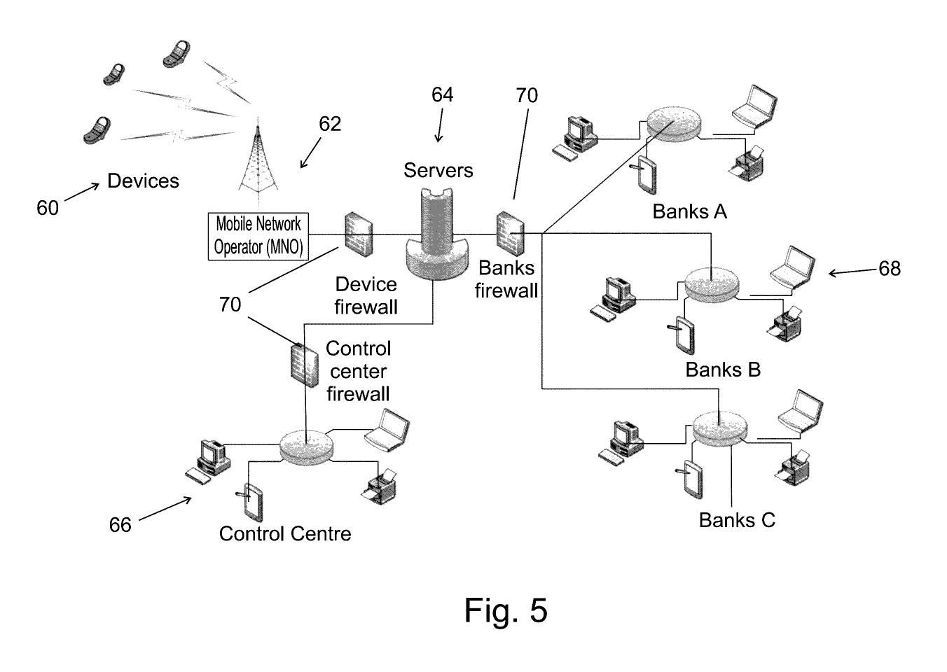

Reference is now made to FIG. 5, which illustrates the payment system topology in which the device operates. The devices are able to encounter each other at a first level 60. The devices connect to the mobile network at a second level 62. The server provides a third level 64 and these are managed by a control system which forms a fourth level 66. The banks form a fifth level 68. Firewalls 70 protect the servers and the control center.

The above-described device has several advantages. NFC capabilities are provided without requiring an expensive smart phone, thus making the device suitable for developing countries. Given the device can facilitate contactless payments without the need of a POS terminal, the solution is suitable for regions where POS terminal infrastructure is under-developed and where most retail transactions resemble the person-to-person use case. The balances, or electronic account entries reflecting the transactions that occur, are stored on the device so that a connection to the server is not required at the time the transaction is carried out. Thus the device can be used in places where or when mobile signals are not available. Also neither party gets to know the details of the other party, since the devices carry out their authentication with each other automatically and only identify genuine devices, as opposed to identifying the user. It is noted that a device identification number which is unique to each device may be linked to a user's account and thus each device can be traced to a specific user.

The device may include some or all of the following security features:

Sensitive data such as device identification number, user identification number, transaction logs and encryption keys may be stored in a secure element. The secure element may also execute cryptographic operations.

The device may have a finger print reader which a user uses to unlock the device for use.

No user may alter or install any software in the device thus the risk of hacking the device is minimized. The only port the device has is for charging.

The device may detect disassembly and or tampering and in doing so, the memory, for example a flash memory or EEPROM, may self-destruct or self-delete. Alternatively, the memory can be fabricated in such a way that accessing or altering its data except via the interfaces provided is physically impossible. The device may also self-destruct or lock itself when it detects disassembly or tampering.

When the NFC facility is not called for, the NFC module may be powered OFF. This is to prevent remote readers from accessing information from the device and also this extends battery life. The NFC module in the device powers ON once a user confirms a contactless payment transaction or when a user activates their device so as to receive a contactless payment. When the NFC module is activated, it is only active for a predetermined time, say five seconds, within which the two devices may be tapped together. If within the period the devices are not tapped, the NFC module switches off and the user is required to repeat the keying in sequence necessary to make the contactless payment transaction. If a user repeats the above process a certain number of times for example five times without tapping another device, the user's device may be deactivated for a certain time period. This is because this behavior is an anomaly and may signify a user trying to hack the device by collecting information emitted by the NFC unit.

Transactional data transmitted by the devices are encrypted, as mentioned above.

If a user is in an area without a mobile network the device can accept a specified number of contactless payment transactions, transact a set threshold cumulative amount or after a certain time period has elapsed after the last successful synchronization, prompt the user to go to a place where there is a network so that the transaction logs already stored in the device can be synchronized with those stored in the servers. Once the parameters described above are met, the user cannot do any transactions until the synchronization process is complete. This ensures the server does not get too far behind and or minimize the risk that a large amount of transactions will not end up at the server in the case the device is damaged. Money transfers or remote payments can only be affected when the user's device is online or within network coverage.

If the device gets lost, it can be disabled through one or more of the following ways:
Going to any bank and upon producing identification documentation, the bank staff will be able to deactivate the user's device.
When a user is first issued with a device, they may be issued with a device deactivation code. If their device is lost, they may simply use any other device, key in the device deactivation code and their user identification number and their device will be deactivated.
A user can also log into their profile in a web portal and using the device deactivation code and their user identification number, deactivate the device.

Once the servers receive instructions to deactivate a device, the servers may send instructions to the device to be deactivated. The device to be deactivated may deactivate itself such that it cannot make any transactions. Before it deactivates itself, the device may send the transaction logs stored in its secure element to the servers. After that, the secure element may format or self-destruct and the device will be unusable.

The server may have extensive data analytics capabilities which help in detecting fraud, money laundering and other anomalies.

Following manufacture, each device may have a SIM card pre-installed at the factory, which enables it to connect to a mobile service provider's network. The IMEI numbers and the phone numbers or IMSI numbers may then be uploaded into the payment server. Other cryptographic codes may also be provided and uploaded.

An end user then orders a device. The financial institution associates the user's bank account with the device IMEI number issued to the user. The device provider servers may then be provided by the bank servers the account information of the user together with the device IMEI number issued to the user.

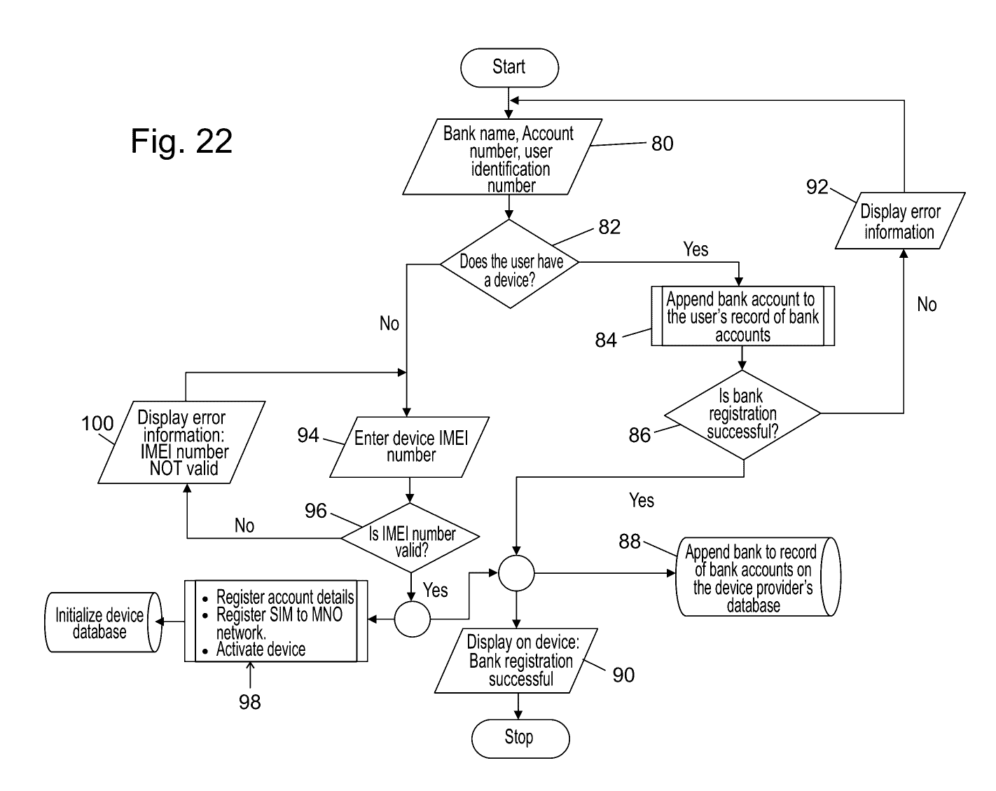

If the user has a second bank account at a second bank then the same device may be linked to the second bank account. This may be done by the device IMEI number being associated or linked with the user's second bank account at the second bank. The procedure is illustrated in greater detail below in respect of FIG. 22.

Once the user has been issued with the device, the device provider server sends the IMSI number associated with the user device's IMEI number to the partner mobile operator servers so as to activate the SIM in the user's device. Once the SIM is registered in the mobile service provider's network, the user can begin to use their device. This setup ensures the bank only has the IMEI number associated with the user's device and the mobile operator has the IMSI number associated with the user's device. The device provider is the only entity with both the user's device IMEI and IMSI number. During registration, the device provider server(s) may generate a device identification number (UDID-Unique Device Identification) which it sends to the device and is stored in the device's secure element. The device identification number provides a more secure way of uniquely identifying each device in addition to the IMEI number (just in case the mobile operator will require the IMEI number in addition to the IMEI number for regulatory or policy purposes).

Once a user first receives their device, the first thing that they need to do is to access their bank account so as to pull or withdraw their funds electronically from their bank account to their device. The user can also receive funds from another device or cash in at an agent outlet.

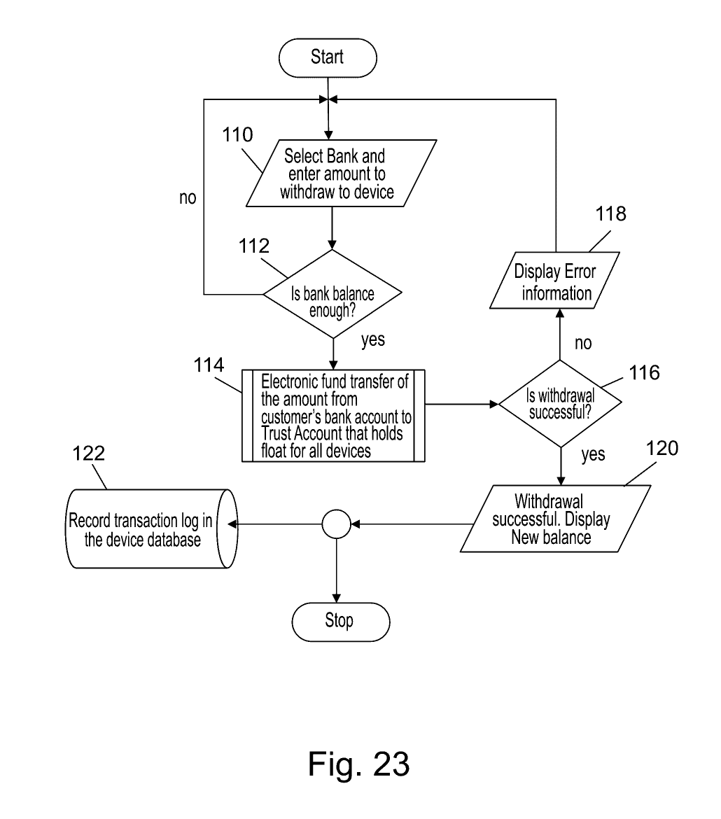

From a technical view point, when a user withdraws money from their bank account to their device, funds are in essence transferred from their bank account to a trust account. The trust account holds all the funds held in all the devices. FIG. 23, discussed below, shows a procedure for carrying out such a withdrawal.

In the above, reference has been made to payments made between two nearby devices using local communication which we refer to as contactless payments. These contactless payments cater for those everyday retail payments between individuals who are in close proximity, for example buying vegetables in a shop or a market stall and the payment is done within the confines of the grocery shop, between the buyer and the shop keeper.

The steps and processes for affecting contactless payments are as follows:

Two individuals enter into an agreement that will result in a monetary payment.

The individual paying the outstanding amount (debtor) gets out their device, unlocks it using the finger print reader, opens the required application module to make contactless payments, and keys in the outstanding amount. The device then checks if the debtor has enough efloat balance i.e. the efloat balance within the secure element may be greater than or equal to the amount to be paid by the debtor plus the transaction fee. If the balance is not sufficient, the debtor is notified and the transaction is disallowed. If the balance is sufficient, the NFC module within the device may be activated for five seconds, ready to send and receive the required transaction information.

The creditor then activates their device so as to receive the payment. On activating, the creditor's device NFC module may also be activated for five seconds. The debtor then taps the upper portion of their device against the upper portion of the creditor's device.

The debtor's device sends the following information to the creditor's device: transaction amount, identification code, and time stamp. All the information shared between the two devices is encrypted.

The creditor's device receives the transaction information sent from the debtor's device and upon successfully decrypting the information, sends to the debtor's device its encrypted identification code.

If the creditor's device cannot decrypt what the debtor's device has sent, then the creditor's device does not vibrate therefore notifying the creditor that the transaction is not complete, and the conclusion being that the debtor has not successfully made the payment. Likewise, if the debtor's device cannot decrypt the identification code sent to it by the creditors' device it will not vibrate, thus prompting the debtor that the transaction is incomplete.

Fake devices are in this way unable to participate in transactions, since they are unable to cause the other device to vibrate and complete the transaction. From time to time, the encryption keys in all devices may be changed during device software updates for added security.

Both devices may then vibrate, or produce another type of stimuli e.g. a beep, to notify the users that the transaction is successful. Also a message may be displayed on the screen that notifies the creditor and debtor that the transaction is successful.

The debtor's device then debits the efloat balance stored within its secure element with the transaction amount and any transaction fee, while the creditors device credits the efloat balance stored within its secure element with the transaction amount the debtor sent and debits any transaction fee due from the creditor.

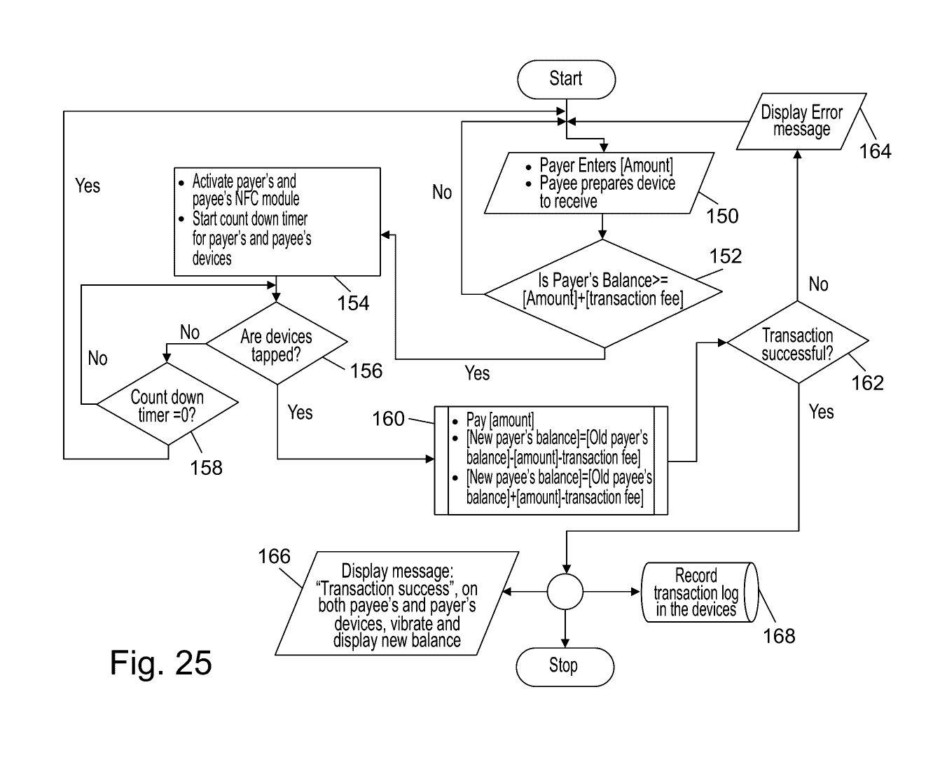

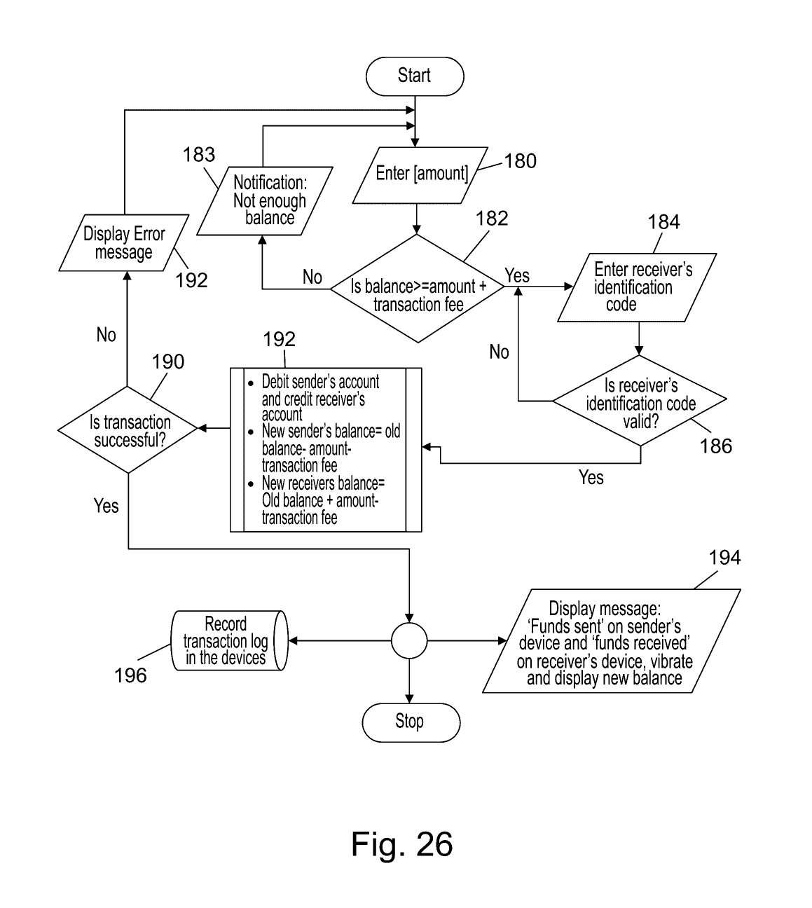

Transaction logs, may contain the debtor's and creditor's identification codes, the transaction amount, type of transaction, a time stamp, and the efloat ending balance, and are kept in each of the creditor's and debtor's device. The time stamp, together with the debtor's and creditor's identification codes, may be used as the transaction ID which identifies the unique transaction. Note that for each transaction made, the debtor and creditor devices may have the same transaction log for that particular transaction, the only difference being that in one device the amount is a credit and in the other device, the amount is a debit. The procedure is discussed below in greater detail in respect of FIG. 25.

From time-to-time, the cellular module within the devices sends the transaction logs via the General Packet Radio Service or any other communication protocol of the mobile service provider, to the device provider servers as in the synchronization process discussed above. Thus the servers have a record of all transactions by the devices from time to time. Upon synchronization, the revenues due to the different banks and the device provider may then be calculated.

Considering the synchronization process in more detail, when the user switches off the device and synchronization has not been done, the device may go into sleep mode but the modules involved in synchronization may remain on and may complete the synchronization of the transaction logs at the first available opportunity. Once the synchronization process is complete the device may then shut down completely. Thus, before a device is completely switched off, the synchronization process should have been completed i.e. synchronization is part of the shutdown sequence.

If a user is in an area without a mobile network and the user switches off their device, the device may then go into sleep mode as described. From time to time it may attempt to connect with the servers in order to synchronize. If after a day the device is unable to contact the servers, it may keep trying twice every day to synchronize. This may continue until the battery runs out of charge.

If a device is not charged and its power reaches a certain threshold, the device may stop accepting any transactions and may automatically synchronize with the servers before initiating shutdown sub-routines.

The algorithm which controls the synchronization process is dependent on the following factors (in order of importance):
1. Value of transactions—if a user carries out large value transactions, their device may synchronize more often with the servers.
2. Number of transactions—if a user carries out many transactions, their device may synchronize more often with the payment servers.
3. Duration—if a user carries out neither of the above, that is both the size and number of the transactions is small, then the device may be synchronized as per a set time frame i.e. all devices need to be synchronized after every 12 hours.

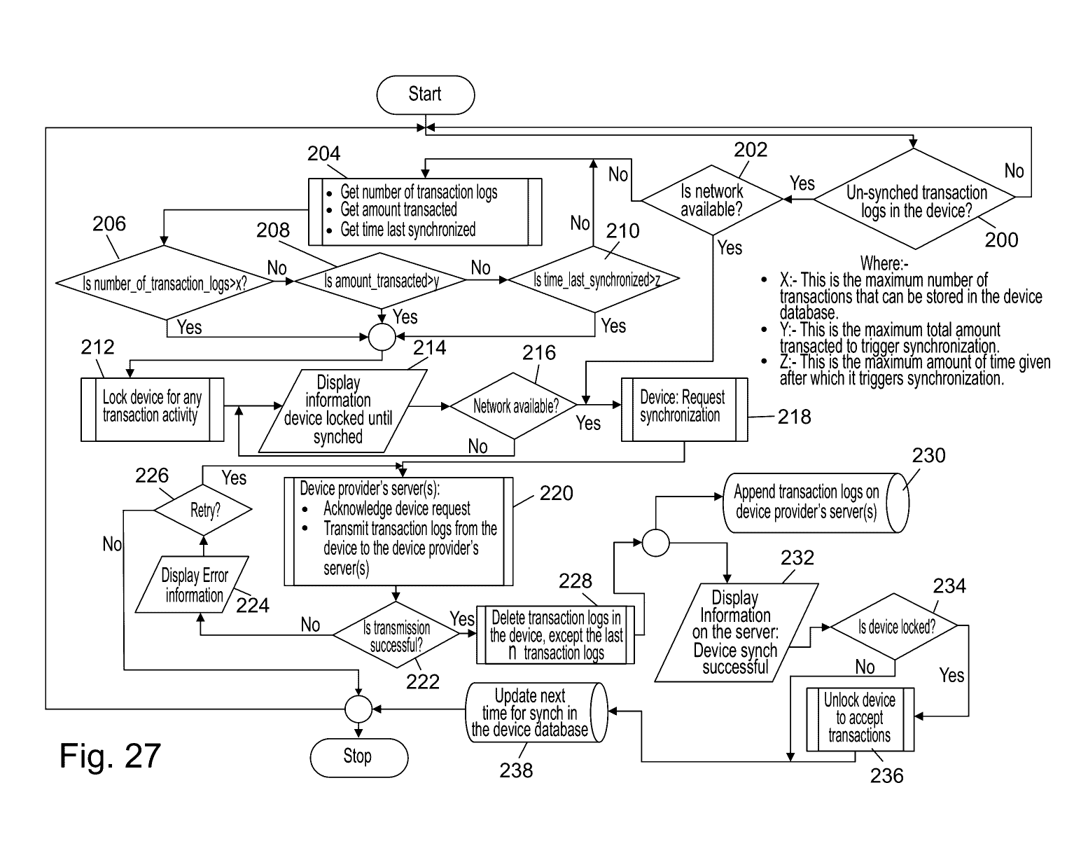

Thus a user who does one or two transactions may have their device synchronizing once in 12 hours. However if the user does a large number of transactions or transactions that are of large amounts, the synchronization process may be more frequent. This provides a safeguard in that it ensures that if a device is damaged the loss is minimized i.e. the chance of having a device with a large unsynchronized balance is minimized. The synchronization procedure is described in greater detail in respect of FIG. 27 hereinbelow.

### Device-to-Device Remote Fund Transfer

If the user wants to send efloat balances to another user via the payment server, the steps and processes are as follows:
1. The sender opens the application module concerned with sending money.
2. The sender keys in the amount to send to the recipient.
3. The device then sends the amount to the payment server. The server then determines the fee associated with sending the amount and sends the fee to the device.
4. If the amount to be sent and the transaction fees are greater than the efloat balance held in the sender's device, then the sender will be prompted that they cannot affect the money transfer. Otherwise, the sender will be prompted to continue with the transaction.
5. The sender keys in the recipient's national identity or passport number. The number sent may be any ID used on a national level to identify citizens i.e. in the United States users may use their social security number. The sender may key any type of user identify number that uniquely identifies a recipient i.e. a phone number.

If the sender is sending electronic funds to a recipient for the first time, they will have to key that person's national identity or passport number. The device will then save the recipient's name and national identity or passport number so that in future the sender simply selects the name of the recipient if they would like to re-send funds to them.

This recipient's national identity or passport number is sent by the sender's device to the payment server which searches its database and then sends the full names of the recipient to the sender's device. Given people recognize names easily rather than numbers, the sender can easily verify beforehand whom they are sending money to. Also, the recipient's device identification code is sent by the server to the sender's device. Alternatively, the device can wait for the user to enter the recipient's national identity number or passport number and the amount to be sent. The device then sends this information to the server and the server sends to the device the full names of the recipient and the fee associated with sending the entered amount.

If a user keys in a national identity or passport number, the names of that person appear on the screen. If this process is repeated a set number of times i.e. three times in a row without proceeding to the next step which is to verify if that is the person the user wants to send money to, the device will not allow fund transfer transactions for a set period e.g. 12 hours. This will ensure individuals do not use their device to mine for other people's names using their national identity or passport numbers.
6. The sender confirms the transaction.
7. The cellular module within the device sends the transaction information in encrypted format (transaction amount, identification code of the sender's device, and time stamp), to the server for onward transmission to the recipient device.
8. The efloat balance in the sender's device is debited with the amount sent and transaction fee. The sender gets a confirmation message that funds have been sent to the recipient and awaiting receipt by the recipient.
9. The payment server then connects with the recipient device with encrypted instructions to credit its efloat balance with the amount sent by the sender. The servers also send to the recipient's device the identification code of the sender's device and the time stamp that was initially generated in the sender's device. The recipient's device confirms the successful credit of its balance with the servers. Afterwards, the sender gets another confirmation message that the amount sent has successfully been received by the recipient. A confirmation message is then received by the recipient that funds have been received. If the payment server cannot get in touch with the recipient's device after a certain time frame i.e. 24 hours, the server may send instructions to the sender's device that may cancel and reverse the transaction, entailing crediting the sender's balance with the amount that was sent and the transaction fee that was debited. The sender's device may then show a notification which notifies the sender the transaction was not successful.
10. The server keeps a record of this transaction. However the transaction logs (which may consist of sender's and receiver's identification codes, transaction amount, efloat ending balance and time stamp, and type of transaction) maintained in the sender and receiver devices may need to be synchronized together with the transaction logs of other transactions. Upon synchronization, the revenues due to the different banks and the device provider may then be calculated. The process is discussed in greater detail below in respect of FIG. 26.

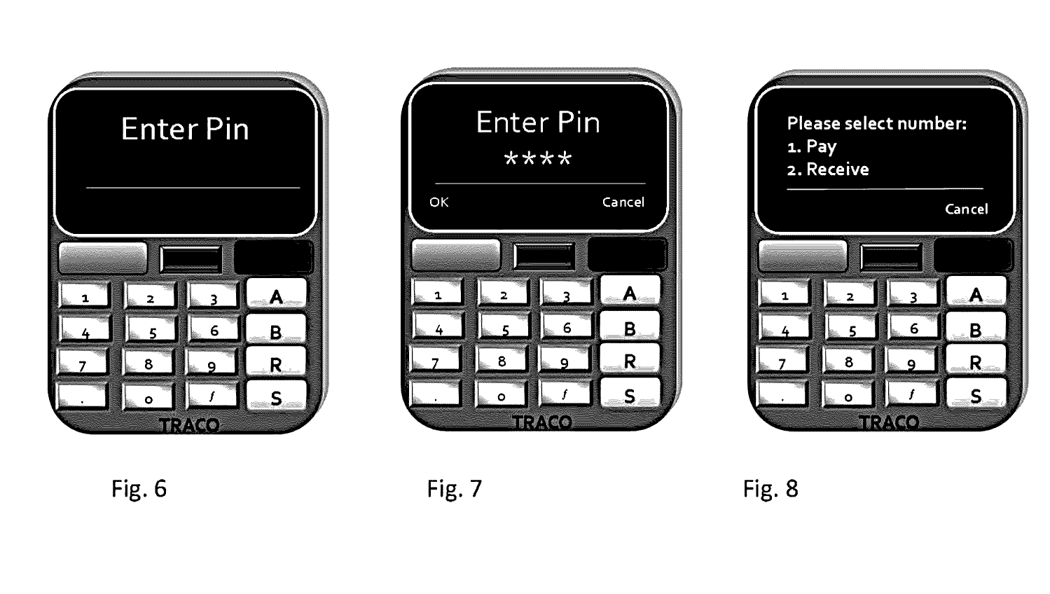

Reference is now made to FIGS. 6 to 17, which illustrate successive screens of the device while carrying out a contactless payment transaction. FIG. 6 shows the screen upon removing the device from one's wallet and pressing any key. Pressing any key causes the device to exit from hibernation mode. After 10 seconds or like predetermined period, of no activity, the device returns to hibernation mode.

FIG. 7 shows the screen as the pin number is entered.

FIG. 8 shows how the device prompts the user to initiate a payment or acceptance of a payment by selecting either a 1 or 2 respectively, using the keypad.

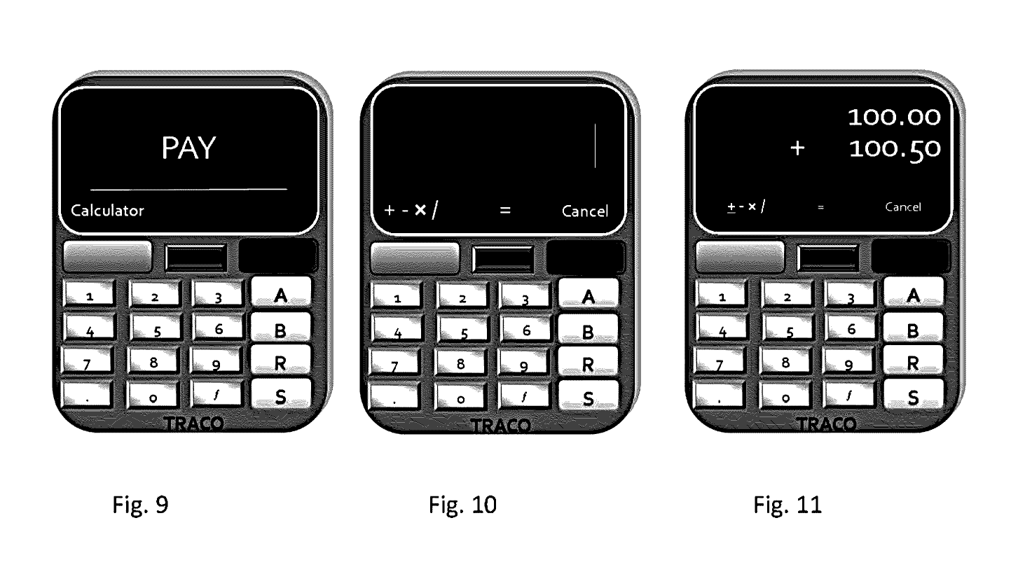

In FIG. 9 the device invites the user to key in the amount to pay. If the user wants to make a calculation then the left navigation key summons a calculator. Otherwise the user simply keys in the amount to pay.

If the calculator key is pressed then the screen shown in FIG. 10 is reached. Repeatedly pressing the left navigation key enables the selection of various mathematical functions.

FIG. 11 shows the screen format once a calculation is about to be completed.

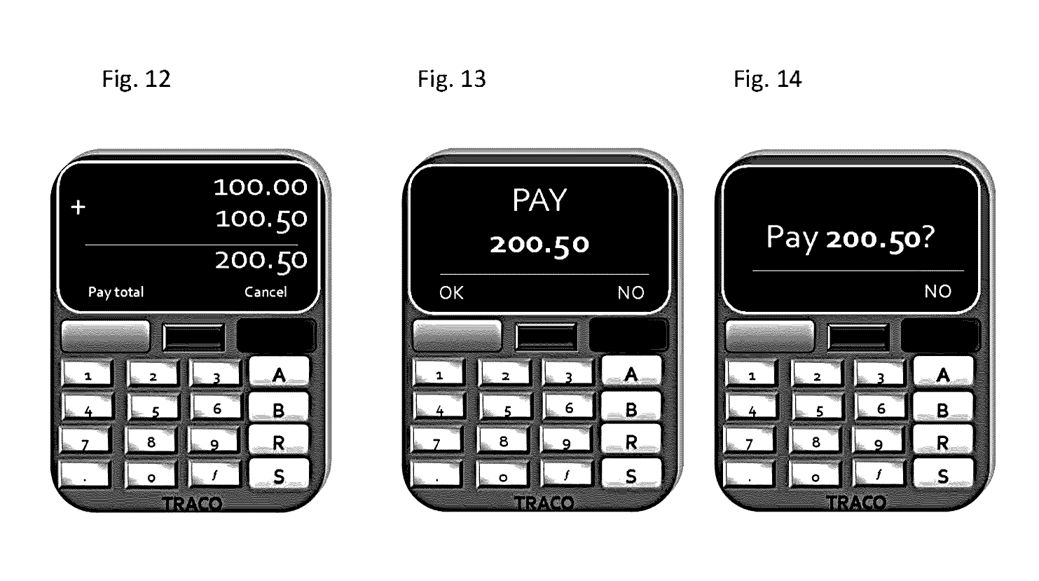

On pressing the equal key, the calculation is performed and the answer is displayed as shown in FIG. 12. On making a calculation the user can easily use the total directly to make a payment.

On pressing the pay total key, the screen changes to the one shown in FIG. 13, showing a single amount that needs to be paid.

On pressing the OK key, the present screen prompts the user to cancel the transaction by pressing the NO key, as shown in FIG. 14. Pressing the OK key activates the NFC module in the device. A transaction then needs to be done within a set period of time e.g. 5 seconds or else the NFC module will be deactivated and the home screen will be displayed.

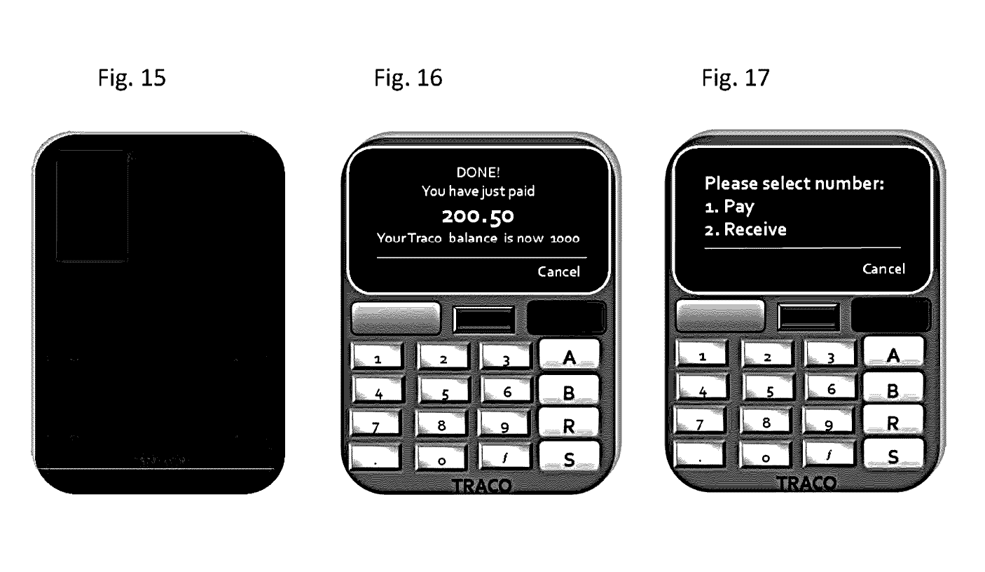

If the user does not want to cancel, they can then simply tap the top end of their device with the top end of another user's device, as per FIG. 15, and the contactless transaction may be carried out. It is noted that in an embodiment, the top end of the device holds the Near Field Communication unit antenna which carries out the contact with the other device.

As per FIG. 16, on tapping the top end of the recipient's device, the user's device vibrates when the transaction is confirmed and the user can easily see their new balance.

As shown in FIG. 17, on pressing cancel, the device is ready to accept or receive a new payment.

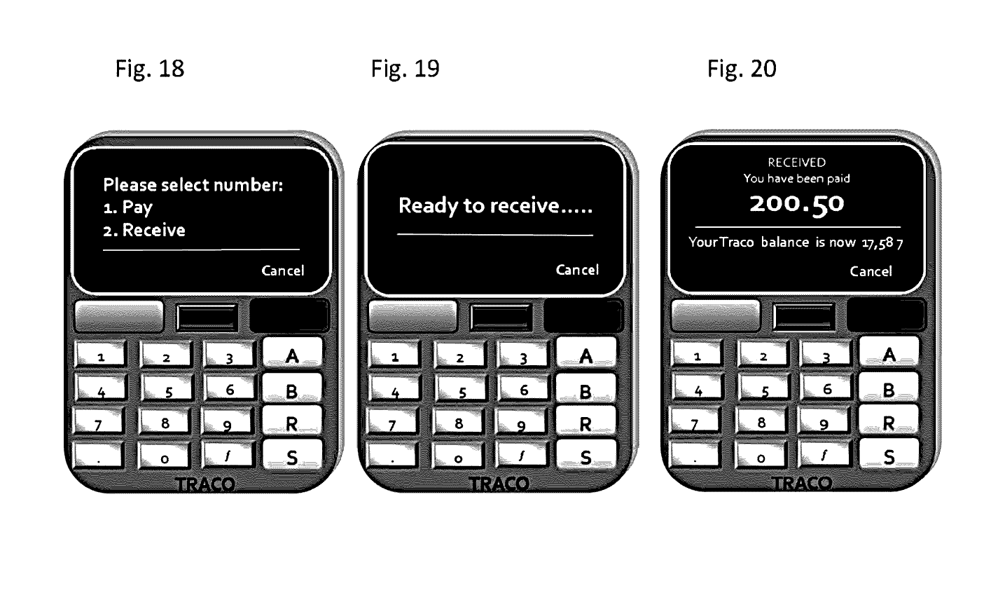

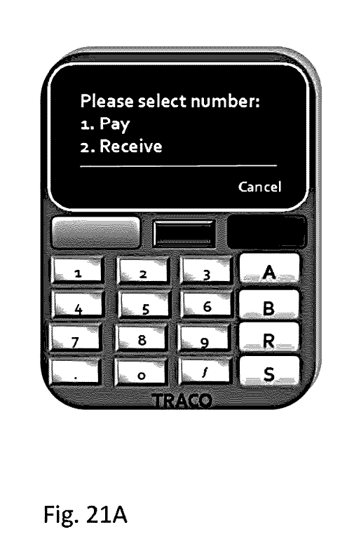

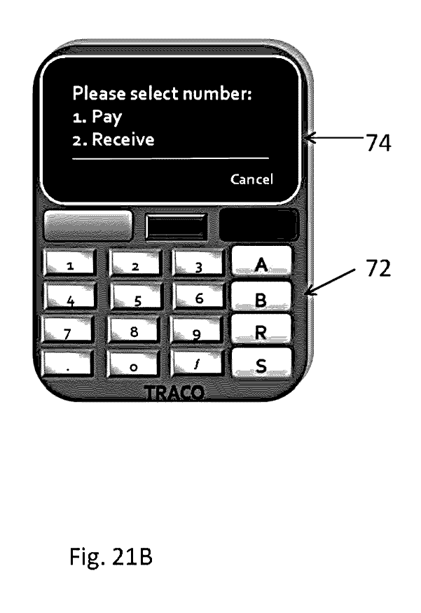

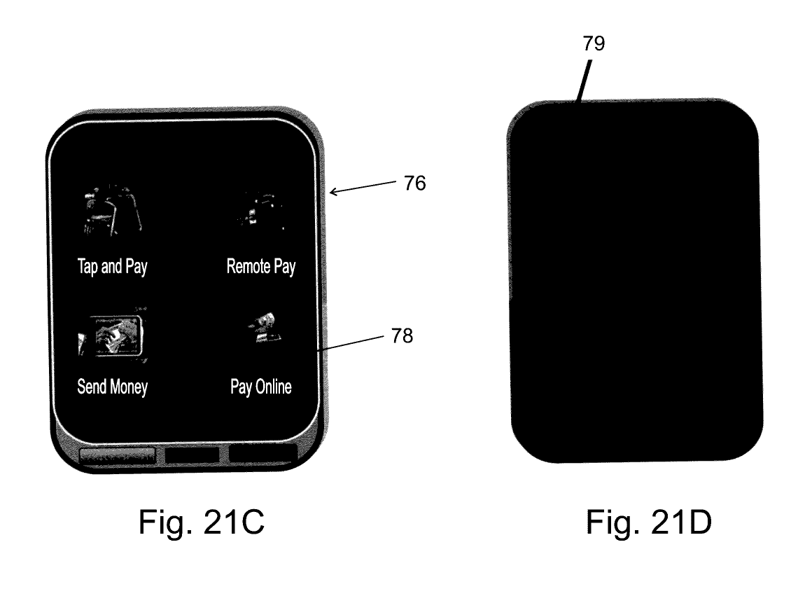

FIG. 18 shows the screen obtained by the recipient after inputting and verifying the PIN as in FIG. 6 and FIG. 7. The screen prompts the recipient as to whether he wants to make a payment or receive a payment. Upon pressing the number 2 on the device keypad, the recipient sees the screen as shown on FIG. 19. The screen of FIG. 19 shows that the device is ready to accept a payment and the Near Field Communication module in the recipient's device is activated for a preset number of seconds as above to receive a payment from the user. Upon the recipient tapping the top end of their device with the top end of the user's device, the transaction is affected and the recipient's device vibrates and shows the confirmation screen as shown in FIG. 20. On pressing the right navigation key which is the cancel key, the user sees the screen shown on FIG. 21A, prompting the user to make another like transaction.

FIG. 21B is a view of a device according to the present embodiments with a keypad 72 and a conventional screen 74.

FIG. 21C is a view of a device according to the present embodiments wherein the screen may be a touch-screen 76, with soft keys 78 appearing and disappearing as and when they are required for processing.

Reference is now made to FIG. 21D, which is a simplified schematic diagram showing the back of a device as shown in FIGS. 6-21C. On the back of the device may be seen finger print reader 79 which is located to be conveniently used by an operator by intuitively and easily moving their index finger.

Reference is now made to FIG. 22, which is a simplified flow chart illustrating the process of registering a new device and linking an extra bank account to an existing device. Bank details, or details of any other institution where the user has an account is provided in box 80. Other details include the bank name, the account number, and a user identification number or the like, such as an official national identity number, social security number etc. In box 82 the details are checked to see whether the user has already been assigned a device. If the user already has a device then flow goes through the yes branch to box 84 and the account details are appended to the user's record of bank accounts for the pre-existing device. If the registration is successful—checked in box 86—then in box 88 the bank account is appended to the device providers' database. In box 90 an acknowledgement of successful registration is provided.

If registration is found to be unsuccessful at box 86 then an error message is shown in box 92 and the registration process starts again.

If the user does not have a pre-existing device, then the IMEI number of a new device is entered in box 94. Validity of the number is checked in box 96. If valid then account details for the new user are registered in the device provider servers. After that, the SIM in the device is registered in the MNO (Mobile Network Operator) network and the device is activated. A device database is then activated 98.

If the IMEI number is not valid then an error message is shown—100—and a valid IMEI number may be entered.

Upon successful initialization of the device then in box 88 the bank account is appended to the device providers' database. In box 90 an acknowledgement of successful registration is provided.

Reference is now made to FIG. 23, which is a simplified diagram that illustrates the process of withdrawing funds from a bank account and loading them as float into the device.

In box 110 the user is able to select which bank and account to withdraw from, assuming the device is connected to more than one account. The amount to withdraw is entered. The account is checked in 112 to make sure that the account has sufficient funds, and if so then in box 114 the amount selected is withdrawn from the customer's account to a trust account that holds float for all the devices. Box 116 checks whether the withdrawal was successful. If not then an error message is shown in 118 and the user has the opportunity to try again.

If the withdrawal was successful then the new float on the device is calculated and displayed on the device in box 120, and the transaction is recorded as a transaction log in the device database—box 122.

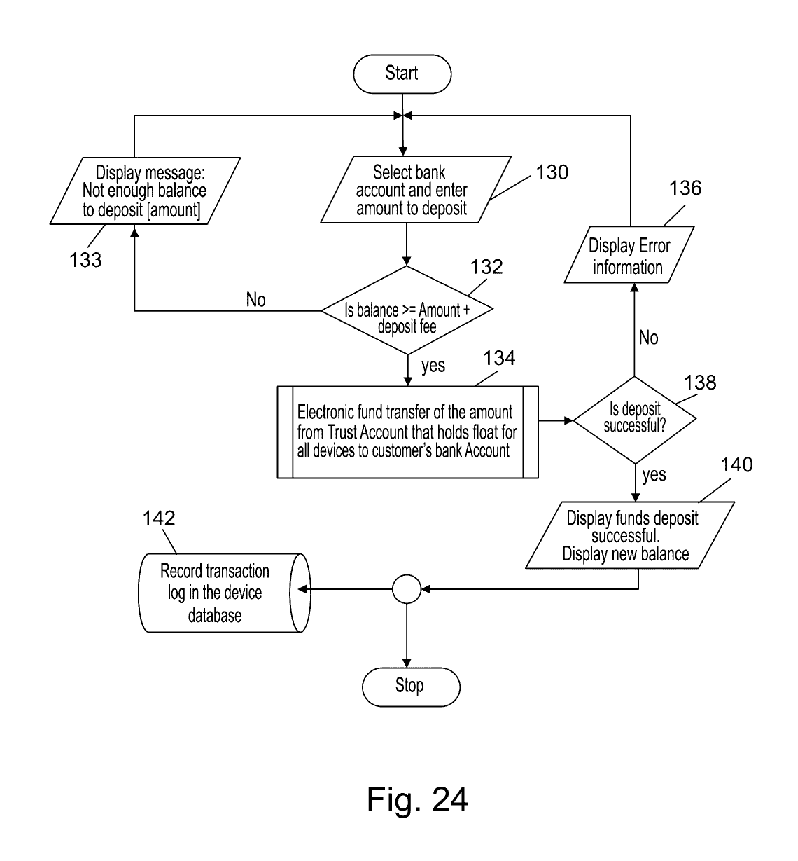

FIG. 24 is a simplified flow chart illustrating how the device can be used to deposit float as funds into a bank account. In box 130 the user selects the bank account—if there is more than one bank account—and the amount to deposit. In box 132 the amount is checked against the current float to ascertain that there is enough to cover the deposit plus any associated fee. If not then an error message is shown—box 133. In box 134 a deposit is made from the trust account to the bank account. In box 138 the device ascertains whether the transaction was successful. If unsuccessful then in box 136, error information is displayed. If successful then, in box 140, the device reports the successful transaction and displays the new float balance. In box 142 the transaction is recorded as a log in the device database.

Reference is now made to FIG. 25, which is a simplified flow chart illustrating the process of making a payment to a nearby device. As discussed, network connection is not required for this process at the time of making the payment, although the transaction details do have to be synchronized eventually. In box 150, the payer enters the amount to be paid while the payee prepares their device to accept the payment amount. In box 152 the amount entered by the payer is checked to make sure that the device has enough float to cover both the payment and any transaction fee. If not the process starts again.

In box 154, the near field communication unit is activated together with a timer. The payer's device is tapped with the payee's device and this is detected in box 156 as long as the timer in both devices have not timed out—box 158. In box 160 the amount is paid and the balances are adjusted accordingly in each device, including any fees. In box 162 the devices check whether the transaction was successful. If not then an error message is displayed 164 and the process may be started again. If successful, then the details are shown on the screen—box 166, the devices then vibrate and the transaction is recorded as a transaction log in the device database for both the devices—box 168, which can be synchronized with the servers either now or at a later time when a network connection is available.

Reference is now made to FIG. 26, which is a simplified flow chart diagram illustrating a remote transaction between two private individuals.

The sender enters the amount to be sent 180. The device checks in box 182 that the float balance in the device is sufficient for the remittance and any associated fee. If not the sender has an opportunity to start again—183. In box 184 the recipient's identification code is entered and in box 186 the code is checked for validity. If not then the sender is given a further opportunity to enter the code. In box 192 the floats in the sender and recipient devices are adjusted accordingly. Box 190 checks that the transaction is successful. If not an error message is displayed—box 192. If the transaction is successful then the sender's device indicates that the amount has been sent to the recipient and the new balance is displayed, box 194. Also the recipient's device indicates the amount has been received from the sender and its new balance is displayed. Box 196 shows that the transaction is recorded as a log in both the sender's and receiver's device database.

Reference is now made to FIG. 27, which is a simplified diagram illustrating the synchronization process. In general synchronization is carried out at the next available opportunity that a network connection is available after a transaction is carried out. However under certain conditions, the device refuses to carry out further transactions if synchronization is not carried out. In box 200 the device determines that it has a logged but unsynchronized transaction. If yes, then in box 202 the device checks whether there is a network connection. If there is no network connection then the flow moves to box 204 where the number of unsynchronized transactions, the transacted amount and the time of last synchronization are obtained. In boxes 206, 208 and 210, each of these values is respectively tested and if any of them exceeds a threshold then flow proceeds to box 212 where transaction activity is locked until the next synchronization. In box 214 the device displays the locked status and no further transactions are carried out until the network is found to be available in box 216.

At this point, box 218—device request synchronization—is reached. Box 218 may also be reached directly from box 202 if the network was available at that time. As the synchronization is requested, the device provider's server acknowledges the device requests and the logs are transmitted to the server, as shown in box 220. In box 222 there is a test for successful transmission. If the transmission is not successful then error information is shown—box 224 and a retry may be attempted 226. A ‘no’ branch is also provided from box 226 if a retry is not to be attempted (and the synchronization process may be started all over again from the beginning).

If the transmission is successful in box 220 then the flow continues from box 222 to box 228, in which all but the last n transaction logs are deleted in the device. The transaction logs of current interest are added to the device provider's server in box 230. In box 232 information about the successful synchronization of the transaction log(s) is displayed. If the device has been locked prior to the current synchronization then this is detected in box 234 and the device is unlocked in box 236. In box 238 a latest time for a next synchronization is updated.

It is expected that during the life of a patent maturing from this application many relevant near field communication methods and devices will be developed and the scope of the term near field communication is intended to include all such new technologies a priori.

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment, and the above description is to be construed as if this combination were explicitly written. Conversely, various features of the invention, which are, for brevity, described in the context of a single embodiment, may also be provided separately or in any suitable subcombination or as suitable in any other described embodiment of the invention, and the above description is to be construed as if these separate embodiments were explicitly written. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A system for carrying out payments, comprising one or more servers and a terminal device, the terminal device synchronizable with the one or more servers over a first electronic network, the terminal device comprising:
a memory containing a stored payment amount;
a local communication unit configured to carry out an authentication handshake with a second device located nearby and to carry out a contactless payment by altering said stored payment amount in a complementary manner at said terminal device and said second device respectively; and
a synchronization unit configured to synchronize said stored payment amount with a server(s) over said first electronic network following alteration thereof due to said payment, and further being configured to carry out said synchronization with said server on detection of a low power condition prior to device shutdown.

2. The system of claim 1, wherein said local communication unit is configured to carry out said authentication handshake and the altering of float irrespective of electronic network connectivity.

3. The system of claim 2, wherein, in the event that either one of said authentication handshake and said altering of float is carried out in the absence of electronic network connectivity, said synchronization unit is configured to wait with said synchronization until network connectivity is regained.

4. The system of claim 1, wherein said local authentication unit comprises a near-field communication unit or Bluetooth module.

5. The system of claim 4, wherein said local authentication unit requires a near field communication or radio communication between said terminal device and said second device.

6. (canceled)

7. A system for carrying out payments, comprising one or more servers and a terminal device, the terminal device synchronizable with the one or more servers over a first electronic network, the terminal device comprising:
a memory containing a stored payment amount;
a local communication unit configured to carry out an authentication handshake with a second device located nearby and to carry out a contactless payment by altering said stored payment amount in a complementary manner at said terminal device and said second device respectively; and
a synchronization unit configured to synchronize said stored payment amount with a server(s) over said first electronic network following alteration thereof due to said payment, and further being configured to carry out said synchronization with said server after a predetermined number of transactions or after elapse of a predetermined time or after reaching a cumulative threshold amount of float transacted.

8. A system for carrying out payments, comprising one or more servers and a terminal device, the terminal device synchronizable with the one or more servers over a first electronic network, the terminal device comprising:
a memory containing a stored payment amount;
a local communication unit configured to carry out an authentication handshake with a second device located nearby and to carry out a contactless payment by altering said stored payment amount in a complementary manner at said terminal device and said second device respectively; and
a synchronization unit configured to synchronize said stored payment amount with a server(s) over said first electronic network following alteration thereof due to said payment, wherein said local communication unit is only open for authentication for a predetermined amount of time following initiation of said authentication by a user.

9. The system of claim 1, wherein said authentication between said terminal device and said second device comprises using a device identification number, authentication protocol and encryption, thereby to retain anonymity of the user.

10. The system of claim 1, wherein said synchronization unit uses a SIM card and authentication protocol to authenticate to said server.

11. The system of claim 1, wherein information exchanged between said terminal device and said second or third device to effect said payment is encrypted.

12. A system for carrying out payments, comprising one or more servers and a terminal device, the terminal device synchronizable with the one or more servers over a first electronic network, the terminal device comprising:
a memory containing a stored payment amount;
a local communication unit configured to carry out an authentication handshake with a second device located nearby and to carry out a contactless payment by altering said stored payment amount in a complementary manner at said terminal device and said second device respectively; and
a synchronization unit configured to synchronize said stored payment amount with a server(s) over said first electronic network following alteration thereof due to said payment, wherein said terminal device further comprises a remote communication unit configured to carry out an authentication handshake with a server, the authentication allowing said server to enable a remote payment to be carried out, the payment being associated with a third device located remotely over said first or a second electronic network, the remote payment comprising altering said stored payment amount in a complementary manner at said terminal device and said third device respectively.

13. A method of carrying out payments between individual users, comprising:
providing each of a plurality of users with a payment device comprising a memory, a remote communication unit and a local communication unit; allowing said users to obtain a negotiable amount from an account, said negotiable amount being stored on a server and copied from said server onto said payment device for use;
remotely communicating with said server to synchronize said negotiable amount between said server and said respective device;
one of said users using their respective devices to define a payment in a transaction with one other of said users;
said two users using said local communication unit to authenticate their respective devices to one another using a device to device authentication making said defined payment by making complementary changes to respective negotiable amounts at each device;
resynchronizing said negotiable amounts with said server following said transaction; and
carrying out said synchronization with said server at least on detection of a low power condition prior to device shutdown.

14. The method of claim 13, comprising carrying out said device to device authentication or said payment transaction irrespective of electronic network connectivity.

15. The method of claim 14, wherein, in the event that either one of said device to device authentication and said payment transaction is carried out in the absence of electronic network connectivity, said synchronizing of said negotiable amounts is delayed until network connectivity is regained.

16. The method of claim 13, wherein said local authentication unit comprises a near-field communication unit or Bluetooth module.

17. The method of claim 16, wherein said local authentication unit requires near field communication or radio communication between said terminal device and said second device.

18. (canceled)

19. A method of carrying out payments between individual users, comprising:
providing each of a plurality of users with a payment device comprising a memory, a remote communication unit and a local communication unit; allowing said users to obtain a negotiable amount from an account, said negotiable amount being stored on a server and copied from said server onto said payment device for use;
remotely communicating with said server to synchronize said negotiable amount between said server and said respective device;
one of said users using their respective devices to define a payment in a transaction with one other of said users;
said two users using said local communication unit to authenticate their respective devices to one another using a device to device authentication making said defined payment by making complementary changes to respective negotiable amounts at each device;
resynchronizing said negotiable amounts with said server following said transaction; and
carrying out said synchronization with said server after a predetermined number of transactions, or after elapse of a predetermined time or after reaching of a cumulative threshold amount transacted.

20. A method of carrying out payments between individual users, comprising:
providing each of a plurality of users with a payment device comprising a memory, a remote communication unit and a local communication unit; allowing said users to obtain a negotiable amount from an account, said negotiable amount being stored on a server and copied from said server onto said payment device for use;
remotely communicating with said server to synchronize said negotiable amount between said server and said respective device;
one of said users using their respective devices to define a payment in a transaction with one other of said users;
said two users using said local communication unit to authenticate their respective devices to one another using a device to device authentication making said defined payment by making complementary changes to respective negotiable amounts at each device; and
resynchronizing said negotiable amounts with said server following said transaction, wherein said local communication unit of either one of said users is only open for authentication for a predetermined amount of time following initiation of said payment transaction by a respective one of said users.

21. The method of claim 13, wherein said device to device authentication comprises authentication of said terminal devices using a device identification number, authentication protocol and encryption, thereby to retain anonymity of the user.

22. The method of claim 13, wherein said terminal devices use a SIM card and encryption to authenticate to said server.

23. The method of claim 13, wherein information exchanged between said devices to effect said payment is encrypted.

24. A method of carrying out payments between individual users, comprising:
providing each of a plurality of users with a payment device comprising a memory, a remote communication unit and a local communication unit; allowing said users to obtain a negotiable amount from an account, said negotiable amount being stored on a server and copied from said server onto said payment device for use;
remotely communicating with said server to synchronize said negotiable amount between said server and said respective device;
one of said users using their respective devices to define a payment in a transaction with one other of said users;
said two users using said local communication unit to authenticate their respective devices to one another using a device to device authentication making said defined payment by making complementary changes to respective negotiable amounts at each device; and
resynchronizing said negotiable amounts with said server following said transaction, wherein said device further comprises a remote communication unit configured to carry out an authentication handshake with said server, said server carrying out a remote payment by altering said negotiable amount in a complementary manner at said terminal device and with a third device respectively, said third device located remotely over said first or a second electronic network.

25. A terminal device for making payments, the device comprising:
a memory containing a stored payment amount;
a local communication unit configured to carry out an authentication handshake with a second device located nearby and to carry out a contactless payment by altering said stored payment amount in a complementary manner at said terminal device and said second device respectively; and
a synchronization unit configured to synchronize said stored payment amount with a server over an electronic network following alteration thereof due to said payment, and further being configured to carry out said synchronization with said server on detection of a low power condition prior to device shutdown.

26. The terminal device of claim 25, further configured to make or receive a payment remotely via communication with said server, a remote authentication handshake being carried out remotely through said server.

27. A system for carrying out payments, comprising one or more servers and a terminal device, the terminal device synchronizable with the one or more servers over a first electronic network, the terminal device comprising:
a memory containing a stored payment amount;
a local communication unit configured to carry out an authentication handshake with a second device located nearby and to carry out a contactless payment by altering said stored payment amount in a complementary manner at said terminal device and said second device respectively, wherein said authentication handshake authenticates said devices without authenticating corresponding users or accounts; and
a synchronization unit configured to synchronize said stored payment amount with one or more server over said first electronic network following alteration thereof due to said payment.
